(19) United States
(12) Patent Application Publication
(10) Pub. No.: US 2013/0189507 A1
(43) Pub. Date: Jul. 25, 2013

(54) DOUBLE-FACED PRESSURE-SENSITIVE ADHESIVE SHEET

(71) Applicant: NITTO DENKO CORPORATION, Osaka (JP)

(72) Inventors: Kenichi YAMAMOTO, Ibaraki-shi (JP); Naoyuki NISHIYAMA, Ibaraki-shi (JP)

(73) Assignee: NITTO DENKO CORPORATION, Osaka (JP)

(21) Appl. No.: 13/747,643

(22) Filed: Jan. 23, 2013

(30) Foreign Application Priority Data
Jan. 25, 2012 (JP) 2012-013573

(51) Int. Cl. C09J 7/04

(52) U.S. Cl. CPC C09J 7/045
USPC 428/219

(57) ABSTRACT

Provided is a double-faced pressure-sensitive adhesive sheet comprising a non-woven fabric substrate, and a pressure-sensitive adhesive layer provided on each of a first face and a second face thereof. The double-faced pressure-sensitive adhesive sheet has a mass per area of 150 g/m² or smaller. 85% or more of its mass corresponds to the combined mass of the pressure-sensitive adhesive layers. The non-woven fabric substrate comprises Manila hemp fibers of 6 μm diameter or larger at a proportion of 25% or more by the number of threads of its constituent fibers.

### BACKGROUND OF THE INVENTION

1. Field of the Invention

The present invention relates to a double-faced pressure-sensitive adhesive (PSA) sheet. In particular, it relates to a double-faced PSA sheet in which PSA is supported by a non-woven fabric substrate.

The present application claims priority based on Japanese Patent Application No. 2012-013573 filed on Jan. 25, 2012 and the entire contents of the application is incorporated in the present description by reference.

2. Description of the Related Art

An adhesively double-faced PSA sheet (double-faced PSA sheet) comprising a PSA layer on each face of a substrate is widely used as an efficient and highly dependable means for attachment in various industrial fields such as home appliances, automobiles, electronic devices, OA devices, and so on.

In late years, from the standpoint of saving natural resources, with respect to recyclable components used in products, there has been an increased number of cases where used products are disassembled, and these components or their constituents are reused (recycled). In the process of reusing a component attached to another member via a double-faced PSA sheet or its constituents, usually, the double-faced PSA sheet needs to be peeled off (removed) from the component for recycling. During the removal, if the surface of the component for recycling is left with partial residue of the double-faced PSA sheet, the efficiency of the recycling process significantly decreases because of the operations to remove such residue from the surface of the recycling component. Situations where the residue might be left on include a case where the double-faced PSA sheet is torn off during the peel-off process, a case where the double-faced PSA sheet is fractured (interlaminarly fractured) in a way such that it is split into the thickness direction inside the non-woven substrate, a case where part of the PSA remains (leaves adhesive residue) on the surface of a component for recycling, and so forth. Technical literatures relating to improvement in such events (increasing recyclability) include Japanese Patent Application Publication Nos. 2006-143856, 2001-152111 and 2000-265140.

### SUMMARY OF THE INVENTION

It is often required for a double-faced PSA sheet used as an attachment means as above to have a property to conform to the surface shape (dents and bumps, curves, etc.) of an adherend (wherein the property may be understood as curved surface adhesion or anti-repulsion property) in addition to the adhesive strength. It is because when the conformability is insufficient, for instance, if used for attachment of a component having an adhesion surface that is non-flat (curved, etc.), floating or peeling, etc. is likely to occur in the joint. Just as in cases where no recycling is involved, also for a double-faced PSA sheet adhered on a component for recycling, needless to say, it is required to have adhesive properties (adhesive strength, curved surface adhesion, etc.) sufficient for serving the primary application purpose of the double-faced PSA sheet. Therefore, in a double-faced PSA sheet used in such an embodiment, it is desired to combine, in a highly balanced manner, opposing properties such as good adhesive properties against an adherend and good removability from the adherend.

Even if a certain double-faced PSA sheet exhibits good removability, due to unexpected events where it is inadequately peeled due to improper removal operations, it has been forgotten to be removed, or the double-faced PSA sheet has been damaged prior to recycling, etc., a component for recycling may be subjected to a subsequent recycling process along with the double-faced PSA sheet or its residue being left on. In such a case, in order to suppress quality loss in the recycled component (to decrease the impurity content), it is effective to reduce the mass per area of the double-faced PSA sheet (i.e., to make the double-faced PSA sheet lighter).

An objective of the present invention is to provide a double-faced PSA sheet comprising a non-woven fabric substrate, with the PSA sheet combining high adhesive properties as well as good removability and also having a small mass per area.

The double-faced PSA sheet disclosed herein comprises a non-woven fabric substrate, a PSA layer provided on each of a first face and a second face of the non-woven fabric substrate. This double-faced PSA sheet has a mass per area of 150 g/m² or smaller (e.g., 100 g/m² to 150 g/m²), of which 85% or more (e.g., 85 to 95%) corresponds to the combined mass of the two PSA layers. The non-woven fabric substrate contains Manila hemp fibers having a fiber diameter of 6 μm or larger at a proportion of 25% or greater by the number of threads of the constituent fibers.

Because a double-faced PSA sheet of such a constitution has a high PSA mass fraction (content), despite of its lightweight, it exhibits excellent adhesive properties (e.g., high adhesive strength as well as good curved surface adhesion). In order to make a lighter double-faced PSA sheet, yet increase the mass fraction of PSA, it is necessary to suppress the grammage of the non-woven fabric substrate to a low level. As such, by employing a non-woven fabric substrate containing some significant amount of Manila hemp fibers that are relatively thick (in particular, having a fiber diameter of 6 μm or larger), even if the non-woven fabric substrate has a low grammage, can be obtained a double-faced PSA sheet having good removability (recyclability). Since the double-faced PSA sheet is lightweight, even if some double-faced PSA sheet residue (which may have been resulted from inadequate peeling, or may have been forgotten to be removed, etc.) remains through recycling processes, quality loss in the recycled component can be suppressed.

The concept of “non-woven fabric” herein mainly refers to a non-woven fabric for PSA sheets used in the field of PSA sheets such as PSA tapes and so on, and typically refers to a non-woven fabric (which may be referred to as so-called “paper”) prepared by a general paper making machine.

A lightweight double-faced PSA sheet as described above may have a small thickness (may have been made thinner). Such a double-faced PSA sheet can be used to form a joint having a smaller thickness. In a preferable embodiment, the double-faced PSA sheet has a thickness of 200 μm or smaller (e.g., 80 μm to 200 μm).

When T_{MD} is the tensile strength in the machine direction (MD) (MD tensile strength) of the double-faced PSA sheet and T_{TD} is the tensile strength in the transverse direction (TD, i.e., the direction perpendicular to MD) (TD tensile strength) thereof, the value of T_{TD}/T_{MD} (TD to MD ratio of tensile strength) is preferably 0.8 or larger, but 1.2 or smaller. With a double-faced PSA sheet with such small direction dependence of tensile strength, when peeling it off from an adherend, the peeling direction is less likely to produce a difference in the removability. Therefore, it is able to exhibit good removability in a more stable manner. In other words, inadequate peeling of the double-faced PSA sheet can be better prevented.

When t_{MD} is the tensile strength in MD (MD tensile strength) of the non-woven fabric substrate and t_{TD} is the tensile strength in TD (TD tensile strength), the value of t_{TD}/t_{MD} is preferably 0.8 or larger, but 1.2 or smaller. Such a non-woven fabric substrate is suitable for making a double-faced PSA sheet that satisfies the T_{TD}/T_{MD} value described above. A non-woven fabric substrate with such small direction dependence of tensile strength is preferable because in general, it is likely to increase the line speed in continuous production using a coater machine, leading to good productivity.

The double-faced PSA sheet disclosed herein can be preferably practiced in an embodiment such that the PSA layer comprises an acrylic PSA as its primary component. In general, acrylic PSA is highly transparent, and thus it is advantageous in terms of the visual quality (e.g., high transparency), etc., of the double-faced PSA sheet. In addition, because the double-faced PSA sheet disclosed herein is lightweight (preferably, lightweight and thin) and also has a high PSA mass fraction, it is suitable for increasing the visual quality. Therefore, in combination with the acrylic PSA, can be obtained a double-faced PSA sheet of even better visual quality.

A preferable non-woven fabric substrate has a grammage lower than 15 g/m² (e.g., of 8 g/m² or higher, but lower than 15 g/m²). The non-woven fabric substrate preferably has a MD tensile strength (t_{MD}) and a TD tensile strength (t_{TD}) of each 0.50 kgf/15 mm or greater (e.g., 0.50 kgf/15 mm to 0.90 kgf/15 mm). According to a fiber composition containing Manila hemp fibers having a fiber diameter of 6 μm or larger at a proportion of 25% or more by the number of threads of the constituent fibers, can be preferably obtained a non-woven fabric substrate that has a low grammage, yet exhibits at least a prescribed level of tensile strength in both MD and TD. It is especially preferable to use a non-woven fabric substrate that satisfies all of the preferable grammage, t_{MD} and t_{TD} values. According to such a non-woven fabric substrate, can be obtained a double-faced PSA sheet of even better removability (e.g., in the recyclability evaluation described later, it can be removed from various plastic materials without leaving any residue).

In a double-faced PSA sheet according to a preferable embodiment, 95% by mass or greater (e.g., 95 to 100% by mass) of the fibers constituting the non-woven fabric substrate are Manila hemp fibers. A non-woven fabric substrate that has such a fiber composition and contains Manila hemp fibers having a fiber diameter of 6 μm or larger at 25% or more by the number of threads is preferable because it may be lightweight, yet have high strength.

The present invention also provides a double-faced PSA sheet produced by a method disclosed herein. Because this PSA sheet exhibits good removability as described above, it is preferable for an application where it is adhered on a component for recycling (e.g. an application of fixing a component for recycling to another component for recycling or a consumable component).

Matters disclosed in this description include a method for fixing a component for recycling to an adherend using a double-faced PSA sheet disclosed herein. A component for recycling on which the double-faced PSA sheet is adhered is also included. Moreover, a product (e.g., home appliances, automobiles, OA devices, etc.) comprising a joint by the double-faced PSA sheet is included.

### BRIEF DESCRIPTION OF THE DRAWINGS

FIG. 1 shows a cross-sectional view schematically illustrating a representative example of a configuration of a double-faced PSA sheet.

FIG. 2 shows a cross-sectional view schematically illustrating another representative example of a configuration of a double-faced PSA sheet.

### DETAILED DESCRIPTION OF THE INVENTION

Preferred embodiments of the present invention are described below. Matters necessary to practice this invention other than those specifically referred to in this description may be understood as design matters to a person of ordinary skills in the art based on the conventional art in the pertinent field.

The present invention can be practiced based on the contents disclosed in this description and common technical knowledge in the subject field.

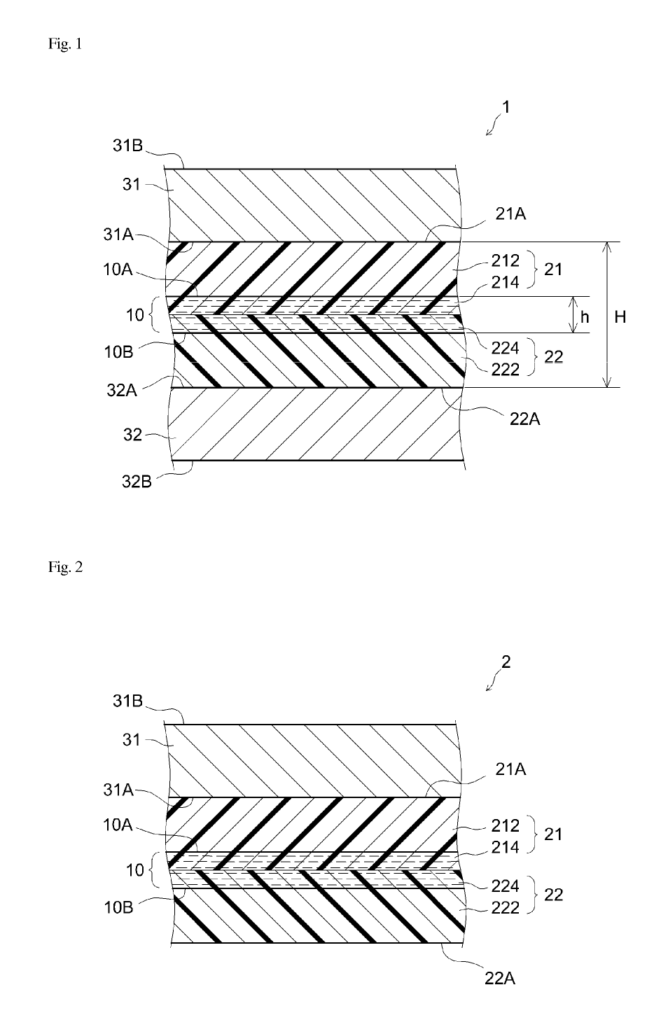

The double-faced PSA sheet (which may be in a form of a long strip such as tape) disclosed herein may have, for instance, a cross-sectional structure shown in FIG. 1 or FIG. 2.

Double-faced PSA sheet 1 shown in FIG. 1 has a configuration where first PSA layer 21 and second PSA layer 22 are provided respectively on first face 10A and second face 10B of non-woven fabric substrate 10. Upper portions (outer portions in this cross section) 212 and 222 of PSA layers 21 and 22 cover first face 10A and second face 10B of non-woven fabric substrate 10, respectively. On the other hand, bottom portions (inner portions in this cross section) 214 and 224 of PSA layers 21 and 22 are integrated into an interior of non-woven fabric substrate 10. Surfaces (first adhesive face 21A and second adhesive face 22A) of PSA layers 21 and 22 are protected with release liners 31 and 32, respectively. In release liners 31 and 32, at least faces (front faces) 31A and 32A facing the PSA layers 21 and 22 are release surfaces (i.e., faces releasable from adhesive faces 21A and 22A). On the other hand, back faces (surfaces opposite to 31A and 32A) 31B and 32B of release liners 31 and 32 may be or may not be release surfaces.

Double-faced PSA sheet 2 shown FIG. 2 has a configuration identical to double-faced PSA sheet 1 shown in FIG. 1, except that front face 31A and back face 31B of release liner 31 are both release surfaces as well as that it does not have release liner 32. With respect to PSA sheet 2 of this type, by winding the PSA sheet 2 to allow the surface (adhesive face 22A) of second PSA layer 22 to contact back face 31B of release liner 31, it can be turned into a configuration where second adhesive face 22A is also protected with release liner 31.

The non-woven fabric substrate comprises Manila hemp fibers among the constituent fibers. It may be a non-woven fabric substrate constituted with fibers consisting essentially of Manila hemp fibers, or a non-woven fabric substrate constituted with Manila hemp fibers as well as one, two or more other kinds of fibers. Preferable examples of the other fibers usable in combination with Manila hemp fibers include a hemp fiber other than Manila hemp fiber, wood fiber (wood pulp, etc.), rayon, a cellulose-based fiber such as acetate, and the like. The other fiber may also be polyester fiber, polyvinyl alcohol (PVA) fiber, polyamide fiber, a polyolefin fiber, polyurethane fiber, or the like.

The non-woven fabric substrate in the art disclosed herein is characterized by comprising Manila hemp fibers having a fiber diameter of 6 μm or larger (hereinafter, a fiber diameter may be indicated as just “φ”, and such a fiber diameter range may be indicated as “φ≧6 μm”) at a proportion of 25% or more (typically 25 to 100%) by the number of threads of the total constituent fibers. A double-faced PSA sheet using such a non-woven fabric substrate may be of good removability from an adherend (e.g., good recyclability described later), even with the non-woven fabric substrate having a low grammage (e.g., 20 g/m² or lower) and with the PSA sheet exhibiting high adhesive strength (e.g., a 180° peel strength of 10 N/20 mm or greater, or even 12 N/20 mm or greater) against an adherend. In a preferable embodiment, the φ≧6 μm Manila hemp fiber content among the constituent fibers is in a range of 25 to 50% by the number of threads. A double-faced PSA sheet using such a non-woven fabric substrate may exhibit, despite of its lightweight, better curved surface adhesion in addition to the adhesive strength and the removability. According to a non-woven fabric substrate with the φ≧6 μm Manila hemp content of 27 to 40% by the number of threads (e.g., 27 to 35% by the number of threads), can be obtained a double-faced PSA sheet combining higher levels of adhesive strength, removability and curved surface adhesion in a balance.

The Manila hemp fiber content (regardless of the fiber diameter) in the constituent fibers of the non-woven fabric substrate is preferably 30% by mass or greater (typically 30 to 100% by mass), more preferably 50% by mass or greater, or even more preferably 70% by mass or greater. The double-faced PSA sheet disclosed herein can be preferably made in an embodiment comprising a non-woven fabric substrate consisting essentially of a cellulose-based fiber (Manila hemp fiber, or a mixture of Manila hemp fiber and another cellulose-based fiber). Among these, preferable is a non-woven fabric substrate constituted with fibers consisting essentially of Manila hemp fibers (typically, constituted with 99 to 100% by mass Manila hemp fibers, e.g., with 100% by mass Manila hemp fibers). In such a non-woven fabric substrate, if 25% or more by the number of threads of the constituent fibers are φ6 μm or larger, it can be said that 25% or more by the number of threads of the constituent fibers are φ≧6 μm Manila hemp fibers.

Herein, the fiber content (% by the number of threads) having a prescribed diameter (e.g., φ6 μm or larger) in the constituent fibers refers to the proportion corresponding to a prescribed fiber diameter relative to the entire distribution, which is determined based on a histogram of data obtained by analysis of fiber cross sections appeared in cross-sectional transmission images taken by a X-ray computed tomography (X-ray CT) scanner. For instance, by applying the method for measuring the fiber diameter described in the worked examples shown later, the φ≧6 μm Manila hemp fiber content (% by the number of threads) can be adequately determined.

In a preferable embodiment of the art disclosed herein, the Manila hemp fiber content having a fiber diameter of 5 μm or larger (hereinafter, it may be indicated as “φ≧5 μm”) in the constituent fibers of the non-woven fabric substrate is 45% or more (typically 45 to 70%) by the number of threads. For instance, can be preferably used a non-woven fabric substrate with the φ≧5 μm Manila hemp fiber content of 50 to 65% (e.g., 55 to 60%) by the number of threads. According to such a non-woven fabric substrate, can be obtained a double-faced PSA sheet combining higher levels of adhesive properties (e.g., adhesive strength and curved surface adhesion) and removability in a balance while being lightweight.

The non-woven fabric substrate is preferably constituted with fibers having a mean fiber diameter (which refers to the median diameter in the histogram of the results obtained by the cross-sectional analysis) of 5.0 μm or larger (e.g., 5.2 μm or larger). According to constituent fibers having such a mean fiber diameter, can be readily obtained a non-woven fabric substrate wherein 25% or more by the number of threads of the constituent fibers are φ≧6 μm Manila hemp fiber. From the standpoint of the surface smoothness of the double-faced PSA sheet (surface roughness of the PSA layer, i.e., roughness of the adhesive surface), usually, a preferable non-woven fabric substrate has a mean fiber diameter of 10.0 μm or smaller (more preferably 8.0 μm or smaller, e.g., 7.0 μm or smaller). Highly smooth surfaces in a double-faced PSA sheet are advantageous in terms of the adhesive strength or the visual quality of the double-faced PSA sheet.

As the non-woven fabric substrate in the art disclosed herein, can be preferably used a non-woven fabric substrate having a grammage of about 20 g/m² or lower (e.g., about 10 g/m² or higher, but lower than 20 g/m²). A non-woven fabric substrate having such a grammage is suitable for constituting a double-faced PSA sheet that is lightweight, yet exhibits good adhesive properties. From the standpoint of the visual quality (transparency, etc.) of the double-faced PSA sheet, preferable is a non-woven fabric substrate having a grammage of 17 g/m² or lower (typically 10 g/m² to 17 g/m²), and especially preferable is a non-woven fabric substrate having a grammage of 15 g/m² or lower (typically 10 g/m² to 15 g/m², e.g., 12 g/m² or higher, but lower than 15 g/m²).

In the art disclosed herein, the non-woven fabric substrate has a thickness of suitably about 70 μm or smaller (e.g., 30 μm to 70 μm), or preferably 60 μm or smaller (e.g., 35 μm to 60 μm). In a double-faced PSA sheet according to a preferable embodiment, the non-woven fabric substrate has a thickness of 40 μm to 55 μm (e.g., 45 μm to 55 μm). A non-woven fabric substrate having such a thickness is suitable for forming a thinner double-faced PSA sheet. It is also preferable because it is likely to produce a double-faced PSA sheet exhibiting a good balance of adhesive properties and removability (more preferably, even visual quality).

From the standpoint of preventing an event where the double-faced PSA sheet is torn off along the way of its removal, it is preferable to use a highly durable non-woven fabric substrate as a component of the double-faced PSA sheet. For instance, it is preferable that the tensile strength measured by the method described in the worked examples shown later is 0.45 kgf/15 mm or greater (more preferably 0.50 kgf/15 mm or greater) either in the machine direction (MD tensile strength t_{MD}; MD can be understood as the longitudinal direction (direction perpendicular to TD)) or in the transverse direction (TD tensile strength, t_{TD}). Although the upper limit of the tensile strength t_{MD} or t_{TD} is not particularly limited, in view of the costs or the ease of reducing the weight, usually, it is preferable to use a non-woven fabric substrate having t_{MD} and t_{TD} of each about 1.0 kgf/15 mm or smaller (typically, 0.80 kgf/15 mm or smaller, e.g., 0.70 kgf/15 mm or smaller). The double-faced PSA sheet disclosed herein may be preferably made in an embodiment comprising a non-woven fabric substrate having t_{MD} and t_{TD} of each about 0.45 kgf/15 mm to 0.8 kgf/15 mm (e.g., 0.50 kgf/15 mm to 0.70 kgf/15 mm). Such a double-faced PSA sheet may achieve a good balance of adhesive properties and removability at a high level while being lightweight.

It is preferable that the non-woven fabric substrate has a ratio of tensile strength t_{TD} to t_{MD} (TD to MD ratio (t_{TD}/t_{MD})) not substantially larger or smaller than 1. For instance, can be preferably used a non-woven fabric substrate having a t_{TD}/t_{MD} in a range of 0.8 to 1.2 (typically 0.8 to 1.1, e.g., 0.9 to 1.1). With a double-faced PSA sheet with such small direction dependence of tensile strength, when peeling it off from an adherend, the peeling direction is less likely to produce a difference in the removability. Therefore, good removability can be produced more stably, and inadequate peeling of the double-faced PSA sheet can be better prevented.

With respect to the tensile strength measured by the method described in the worked examples shown later, the non-woven fabric substrate has a tear strength in the longitudinal direction (MD tear strength), s_{MD}, and a tear strength in the transverse direction (TD tear strength), s_{TD}, of each preferably 350 mN or greater, or more preferably 400 mN or greater. Although the upper limit of the tear strength s_{MD} or s_{TD} is not particularly limited, in view of the costs or the ease of reducing the weight, usually, it is preferable to use a non-woven fabric substrate having s_{MD} and s_{TD} of each about 700 mN or smaller (typically, 600 mN or smaller, e.g., 500 mN or smaller). The double-faced PSA sheet disclosed herein may be preferably made in an embodiment comprising a non-woven fabric substrate having s_{MD} and s_{TD} of each about 350 mN to 600 mN (e.g., 400 mN to 500 mN). Such a double-faced PSA sheet may achieve a good balance of adhesive properties and removability at a high level while being lightweight.

It is preferable that the non-woven fabric substrate has a ratio of tear strength s_{TD} to s_{MD} (TD to MD ratio (s_{TD}/s_{MD})) not substantially larger or smaller than 1. For instance, can be preferably used a non-woven fabric substrate having a s_{TD}/s_{MD} in a range of 0.8 to 1.2. In a double-faced PSA sheet with such small direction dependence of tear strength, when peeling it off from an adherend, the peeling direction is less likely to produce a difference in the removability. Therefore, good removability can be produced more stably, and inadequate peeling of the double-faced PSA sheet can be better prevented.

In usual, the bulk density (which can be calculated by dividing the grammage by the thickness) of the non-woven fabric substrate is suitably 0.20 g/cm³ to 0.50 g/cm³, or preferably 0.25 g/cm³ to 0.40 g/cm³. When the bulk density is too small, one or either of the preferable tensile strength and the preferable tear strength may be less likely to be achieved. On the other hand, when the bulk density is too large, the level of the integration of the PSA into the non-woven fabric substrate may be insufficient, and as a result, it may lead to a decrease in the removability or some loss in the visual quality, etc. From such a standpoint, it is preferable to use a non-woven fabric substrate having a bulk density of about 0.25 g/cm³ to 0.35 g/cm³ (e.g., 0.25 g/cm³ to 0.30 g/cm³).

As the non-woven fabric substrate in the art disclosed herein, can be preferably used a non-woven fabric substrate having an air resistance R_{1/4} of 0.02 sec to 0.07 sec (more preferably 0.03 sec to 0.07 sec), when the air resistance is determined by dividing the air resistance (Gurley) R₁ measured with respect to four overlaid sheets of the non-woven substrate as a sample, by the number of the overlaid sheets (i.e., 4). Herein, the air resistance (Gurley) R₁ can be determined by measuring and computing, using a commercially available Gurley tester (preferably model B), in accordance with the Gurley tester method specified in BS P8117:1998, the time required for a prescribed amount of air to permeate through the sample (herein, the sample is obtained by overlaying four sheets of the non-woven fabric).

A non-woven fabric substrate with such small air resistance as described above well integrates PSA into itself. Therefore, can be readily obtained a double-faced PSA sheet in which the interfiber open space (interfiber gap) in the non-woven fabric substrate is more thoroughly filled with PSA (i.e., with less open space remaining). Such a double-faced PSA sheet may turn out to be of better removability (e.g., having high adhesive strength, yet being more resistant to an interlaminar fracture or tearing) as compared to a double-faced PSA sheet with many open spaces remaining within its non-woven fabric substrate. It may also exhibit even better curved adhesion. It may be of good visual quality (e.g., transparency) as well. A non-woven fabric substrate comprising 25% or more (more preferably 30% or more) of φ≧6 μm Manila hemp fiber by the number of threads and having a grammage lower than 20 g/m² (more preferably of 15 g/m² or lower) is preferable since it is likely to satisfy the prescribed air resistance.

The non-woven fabric substrate can be produced based on a known method for fabricating non-woven fabrics (e.g., non-woven fabrics primarily comprising a cellulose fiber (so-called “paper”, etc.)), or by suitably modifying the fabrication method where necessary, or by selecting suitable conditions and procedures. A method for producing a non-woven fabric according to a preferable embodiment typically comprises preparing a dispersion which contains raw fibers in a liquid medium (typically a liquid medium primarily comprising water (an aqueous medium, e.g., water), and forming a sheet (making paper) from this dispersion. Prior to forming a sheet, the raw fibers may be subjected to beating, or may not be subjected to beating (i.e., paper may be made from unbeaten raw fibers).

The mean fiber diameter, the fiber diameter distribution (e.g., the proportion of fibers having a prescribed fiber diameter), and the air resistance, etc., of the non-woven fabric substrate can be adjusted, for instance, by the characteristics of the raw fibers to be used, whether or not the beating process has been given and the extent of the given process, and so on. In a preferable embodiment of the art disclosed herein, a non-woven fabric substrate obtained by forming a sheet from unbeaten raw fibers is used. This method may be preferably applied to fabrication of a non-woven fabric substrate comprising 25% or more of φ≧6 μm Manila hemp fibers by the number of threads. It is preferable as a method for producing a non-woven fabric substrate of low air resistance. The grammage, the thickness, the density, the TD to MD ratio of the tensile strength (t_{TD}/t_{MD}), and the TD to MD ratio of the tear strength (s_{TD}/s_{MD}), etc., can be adjusted by the sheet forming conditions, the conditions for the subsequent drying process, the pressing conditions, and so on.

Other than the constituent fibers as describe above, the non-woven fabric substrate may further comprise a resin component such as starch (e.g., cationized starch), polyacrylamide, viscose, polyvinyl alcohol, urea formaldehyde resin, melamine formaldehyde resin, polyamide polyamine epichlorohydrin, or the like. The resin component may serve as a paper strengthening agent in the non-woven fabric substrate. By using such a resin component as necessary, the strength (e.g., one or both of the tensile strength and the tear strength) of a non-woven fabric substrate can be adjusted. The non-woven fabric substrate in the art disclosed herein may further comprise as necessary an additive generally used in the field related to production of non-woven fabrics, such as an yield-increasing agent, a drainage-aiding agent, viscosity-adjusting agent, a dispersing agent, or the like.

In the art disclosed herein, the type of PSA contained in the PSA layer is not particularly limited. For instance, it may be a PSA comprising as its base polymer one, two or more kinds selected from various polymers (pressure-sensitively adhesive polymers) such as acrylic, polyester-based, urethane-based, polyether-based, rubber-based, silicone-based, polyamide-based, fluorine-based polymers capable of serving as pressure-sensitively adhesive components. In a preferable embodiment, the PSA layer comprises as its primary component an acrylic PSA. The art disclosed herein can be preferably practiced in a form of a double-faced PSA sheet comprising a PSA layer consisting essentially of an acrylic PSA.

Herein, “acrylic PSA” refers to a PSA comprising an acrylic polymer as a base polymer (a primary component of polymer components, i.e., a component accounting for 50% by mass or more). “Acrylic polymer” refers to a polymer comprising as its primary monomer component (a primary component of monomers, i.e., a component accounting for 50% by mass or more of all monomers constituting the acrylic polymer) a monomer having at least one (meth)acryloyl group per molecule (hereinafter, this may be referred to as “acrylic monomer”). In this description, “(meth)acryloyl group” comprehensively refers to acryloyl group and methacryloyl group. Similarly, “(meth)acrylate” comprehensively refers to acrylate and methacrylate.

The acrylic polymer is typically a polymer comprising as its primary monomer component an acrylic (meth)acrylate. As the alkyl (meth)acrylate, for instance, can be preferably used a compound represented by the following formula (1):

CH₂═C(R¹)COOR² (1)

Herein, R¹ the formula (1) is a hydrogen atom or a methyl group. R² is an alkyl group having 1 to 20 carbon atoms. Because of a likelihood of obtaining a PSA having good adhesive properties, preferable is an alkyl (meth)acrylate wherein R² is an alkyl group having 2 to 14 carbon atoms (hereinafter, such a range of the number of carbon atoms may be indicated as C₂₋₁₄). Examples of a C₂₋₁₄ alkyl group include methyl group, ethyl group, propyl group, isopropyl group, n-butyl group, isobutyl-group, s-butyl group, t-butyl group, n-pentyl group, isoamyl group, neopentyl group, n-hexyl group, n-heptyl group, n-octyl group, isooctyl group, 2-ethylhexyl group, n-nonyl group, isononyl group, n-decyl group, isodecyl group, n-undecyl group, n-dodecyl group, n-tridecyl group, n-tetradecyl group, and the like.

In a preferable embodiment, of the total mount of monomers used for the synthesis of an acrylic polymer, about 50% by mass or greater (typically 50 to 99.9% by mass), or more preferably 70% by mass or greater (typically 70 to 99.9% by mass), for example, about 85% by mass or greater (typically 85 to 99.9% by mass), is attributed to one, two or more species selected from alkyl (meth)acrylates with R² in the formula (1) being a C₂₋₁₄ alkyl group (more preferably C₄₋₁₀ alkyl (meth)acrylates, with one or both of n-butyl acrylate and 2-ethylhexyl acrylate being particularly preferable). An acrylic polymer obtained from such a monomer composition is preferable because it allows formation of a PSA that exhibits good adhesive properties.

As the acrylic polymer in the art disclosed herein, can be preferably used a polymer in which an acrylic monomer having a hydroxyl group (—OH) is copolymerized. Examples of a hydroxyl-group-containing acrylic monomer include 2-hydroxyethyl (meth)acrylate, 2-hydroxypropyl (meth)acrylate, 3-hydroxypropyl (meth)acrylate, 2-hydroxybutyl (meth)acrylate, 4-hydroxybutyl (meth)acrylate, 2-hydroxyhexyl (meth)acrylate, 6-hydroxyhexyl (meth)acrylate, 8-hydroxyoctyl (meth)acrylate, 10-hydroxydecyl (meth)acrylate, 12-hydroxylauryl (meth)acrylate, (4-hydroxymethylcyclohexyl) methyl acrylate, polypropylene glycol mono(meth)acrylate, N-hydroxyethyl (meth)acrylamide, N-hydroxypropyl (meth)acrylamide, and the like. Such hydroxyl-group-containing acrylic monomers can be used as a single kind alone, or in combination of two or more kinds.

According to an acrylic polymer in which such a hydroxyl-group-containing acrylic monomer is copolymerized, can be preferably obtained a PSA having a good balance of adhesive strength and cohesive strength along with good removability. Especially preferable hydroxyl-group-containing acrylic monomers include hydroxyalkyl (meth)acrylates such as 2-hydroxyethyl (meth)acrylate, 2-hydroxypropyl (meth)acrylate, 3-hydroxypropyl (meth)acrylate, 2-hydroxybutyl (meth)acrylate, 4-hydroxybutyl (meth)acrylate, and the like. For example, can be preferably used a hydroxyalkyl (meth)acrylate with the alkyl group in the hydroxyalkyl group being a straight chain having 2 to 4 carbon atoms.

Such a hydroxyl-group-containing acrylic monomer is preferably used in a range of about 0.001 to 10% by mass of the total amount of monomers used in the synthesis of the acrylic polymer. This may allow formation of a double-faced PSA sheet combining high levels of adhesive strength and cohesive strength in a good balance. By using a hydroxyl-group-containing acrylic monomer in an amount of about 0.01 to 5% by mass (e.g., 0.05 to 2% by mass), even better results may be attained.

In the acrylic polymer in the art disclosed herein, to an extent not significantly vitiating the effects of the present invention, a monomer (the other monomer) besides those mentioned above may be copolymerized. Such a monomer can be used, for instance, for adjusting the Tg of the acrylic polymer, or adjusting the adhesive properties (e.g., peeling property), etc. As monomers capable of increasing the cohesive strength or the heat resistance of PSA, examples include sulfonate-group-containing monomers, phosphate-group-containing monomers, cyano-group-containing monomers, vinyl esters, aromatic vinyl compounds, and the like. As monomers capable of introducing to the acrylic polymer a functional group that may serve as a crosslinking point, or of contributing to improved adhesive strength, other examples include carboxyl-group-containing monomers, acid-anhydride-group-containing monomers, amide-group-containing monomers, amino-group-containing monomers, imide-group-containing monomers, epoxy-group-containing monomers, (meth)acryloylmorpholines, vinyl ethers, and the like

Examples of a sulfonate-group-containing monomer include styrene sulfonate, allyl sulfonate, 2-(meth)acrylamide-2-methyl propane sulfonate, (meth)acrylamide propane sulfonate, sulfopropyl (meth)acrylate, (meth)acryloxynaphthalene sulfonate, sodium vinyl sulfonate, and the like.

Examples of a phosphate-group-containing monomer include 2-hydroxyethylacryloyl phosphate.

Examples of a cyano-group-containing monomer include acrylonitrile, methacrylonitrile, and the like.

Examples of a vinyl ester include vinyl acetate, vinyl propionate, vinyl laurate, and the like.

Examples of an aromatic vinyl compound include styrene, chlorostyrene, chloromethyl styrene, α-methyl styrene, other substituted styrenes, and the like.

Examples of a carboxyl-group-containing monomer include acrylic acid, methacrylic acid, carboxyethyl (meth)acrylate, carboxypentyl (meth)acrylate, itaconic acid, maleic acid, fumaric acid, crotonic acid, isocrotonic acid, and the like.

Examples of an acid-anhydride-group-containing monomer include maleic acid anhydride, itaconic acid anhydride, acid anhydrides of the carboxyl-group-containing monomers listed above, and the like.

Examples of an amide-group-containing monomer include acrylamide, methacrylamide, diethylacrylamide, N-vinylpyrrolidone, N,N-dimethylacrylamide, N,N-dimethylmethacrylamide, N,N-diethylacrylamide, N,N-diethylmethacrylamide, N,N′-methylenebis(acrylamide), N,N-dimethylaminopropylacrylamide, N,N-dimethylaminopropylmethacrylamide, diacetone acrylamide, and the like.

Examples of an amino-group-containing monomer include aminoethyl (meth)acrylate, N,N-dimethylaminoethyl (meth)acrylate, N,N-dimethylaminopropyl (meth)acrylate, and the like.

Examples of an imide-group-containing monomer include cyclohexylmaleimide, isopropylmaleimide, N-cyclohexylmaleimide, itaconimide, and the like.

Examples of an epoxy-group-containing monomer include glycidyl (meth)acrylate, methylglycidyl (meth)acrylate, acryl glycidyl ether, and the like.

Examples of a vinyl ether include, methyl vinyl ether, ethyl vinyl ether, isobutyl vinyl ether, and the like.

Among these “other monomers”, one kind can be used solely, or two or more kinds can be used in combination while their total content is preferably about 40% by mass or less (typically 0.001 to 40% by mass) of the total amount of monomers used for the synthesis of the acrylic polymer, or more preferably about 30% by mass or less (typically 0.01 to 30% by mass, e.g., 0.1 to 10% by mass). When a carboxyl-group-containing monomer is used as the other monomer, its content can be, for instance, 0.1 to 10% by mass of the total amount of monomers, and it is usually suitable to be 0.5 to 5% by mass. When a vinyl ester (e.g., vinyl acetate) is used as the other monomer, its content can be, for instance, 0.1 to 20% by mass of the total amount of monomers, and it is usually suitable to be 0.5 to 10% by mass.

The copolymer composition of the acrylic polymer is suitably designed so that the polymer has a glass transition temperature (Tg) of −15° C. or below (typically −70° C. to −15° C.), preferably −25° C. or below (e.g., −60° C. to −25° C.), or more preferably −40° C. or below (e.g., −60° C. to −40° C.). When the Tg of the acrylic polymer is too high, the adhesive strength (e.g., adhesive strength in a low temperature environment, adhesive strength against rough surfaces) of a PSA containing the acrylic polymer as a base polymer may be likely to decrease. When the Tg of the acrylic polymer is too low, the curved surface adhesion of the PSA may likely to decrease, or the removability may tend to decrease (e.g., PSA residue may be likely to be left on).

The Tg of an acrylic polymer can be adjusted by suitably modifying the monomer composition (i.e., the types of monomers used in the synthesis of the polymer or their employed ratio). Herein, the Tg of an acrylic polymer refers to a value determined from the Fox equation based on the Tg values of the homopolymers of the respective monomers constituting the polymer and the mass fractions (copolymerization ratio based on the mass) of these monomers. As the Tg values of homopolymers, values given in a known document are used.

In the art disclosed herein, as the Tg values of the homopolymers, the following values are used specifically:

| | |
|---|---|
| 2-ethylhexyl acrylate | −70° C. |
| n-butyl acrylate | −55° C. |
| ethyl acrylate | −22° C. |
| methyl acrylate | 8° C. |
| methyl methacrylate | 105° C. |
| cyclohexyl methacrylate | 66° C. |
| vinyl acetate | 32° C. |
| styrene | 100° C. |
| acrylic acid | 106° C. |
| methacrylic acid | 130° C. |

With respect to the Tg values of homopolymers other than the examples listed above, the values given in “Polymer Handbook” (3rd edition, John Wiley & Sons, Inc., Year 1989) are used.

When no values are given in the “Polymer Handbook” (3rd edition, John Wiley & Sons, Inc., Year 1989), values obtained by the following measurement method are used (see Japanese Patent Application Publication No. 2007-51271).

In particular, to a reaction vessel equipped with a thermometer, a stirrer, a nitrogen inlet and a condenser, are added 100 parts by mass of monomer, 0.2 part by mass of azobisisobutyronitrile, and 200 parts by mass of ethyl acetate as a polymerization solvent, and the mixture is stirred for one hour under a nitrogen gas flow. After oxygen is removed in this way from the polymerization system, the mixture is heated to 63° C. and the reaction is carried out for 10 hours. Then, it is cooled to room temperature, and a homopolymer solution having 33% by mass solids content is obtained. Then, this homopolymer solution is applied onto a release liner by flow coating and allowed to dry to prepare a test sample (a sheet of homopolymer) of about 2 mm thickness. This test sample is cut out into a disc of 7.9 mm diameter and is placed between parallel plates; and using a rheometer (ARES, available from Rheometrics Scientific, Inc.), while applying a shear strain at a frequency of 1 Hz, the viscoelasticity is measured in the shear mode over a temperature range of −70° C. to 150° C. at a heating rate of 5° C./min; and the temperature value at the maximum of the tan δ (loss tangent) curve is taken as the Tg of the homopolymer.

The PSA in the art disclosed herein is preferably designed so that the temperature at the maximum of the shear loss modulus G″ is −10° C. or below (typically −40° C. to −10° C.). For example, a preferable PSA is designed such that the temperature at the maximum is −35° C. to −15° C. The temperature at the maximum of the shear loss modulus G″ can be obtained as follows: a disc of 7.9 mm diameter is cut out from a 1 mm thick sheet of PSA and placed between parallel plates; using a rheometer (ARES, available from Rheometrics Scientific, Inc.), while applying a shear strain at a frequency of 1 Hz, the temperature dependence of the shear loss modulus G″ is monitored in the shear mode over a temperature range of −70° C. to 150° C. at a heating rate of 5° C./min; and the temperature at the maximum of the G″ curve (temperature at which the G″ curve is maximal) is determined.

The Tg of an acrylic polymer can be adjusted by suitably modifying the monomer composition (i.e., the types of monomers used in the synthesis of the polymer or their employed ratio). The temperature at the maximum of the shear loss modulus G″ of an acrylic polymer can also be adjusted by suitably modifying the monomer composition (i.e., the types of monomers used in the synthesis of the polymer or their employed ratio).

The method for obtaining an acrylic polymer having such a monomer composition is not particularly limited, and can be suitably employed various polymerization methods known as synthetic methods of an acrylic polymer, such as a solution polymerization method, an emulsion polymerization method, a bulk polymerization method, a suspension polymerization method, and the like. For instance, a solution polymerization method can be preferably used. As a method for supplying monomers when solution polymerization is carried out, can be suitably employed a method such as the all-at-once supply method where all starting monomers are supplied at once, gradual supply (dropping) method, portionwise supply (dropping) method, etc. The polymerization temperature can be suitably selected according to the types of monomer and the type of solvent to be used, the type of polymerization initiator and so on. For example, it can be about 20° C. to 170° C. (typically 40° C. to 140° C.).

The solvent used for solution polymerization can be suitably selected from known or commonly used organic solvents. For example, can be used one kind of solvent or a mixed solvent of two or more kinds selected from aromatic compounds (typically aromatic hydrocarbons) such as toluene, xylene, etc.; aliphatic or alicyclic hydrocarbons such as ethyl acetate, hexane, cyclohexane, methylcyclohexane, etc.; halogenated alkanes such as 1,2-dichloroethane, etc.; lower alcohols (e.g., primary alcohols having 1 to 4 carbon atoms) such as isopropanol, 1-butanol, sec-butanol, tert-butanol, etc.; ethers such as tert-butyl methyl ether, etc.; ketones such as methyl ethyl ketone, acetyl acetone, etc.; and so on. Preferably used is an organic solvent (which may be a mixed solvent) having a boiling temperature in a range of 20° C. to 200° C. (more preferably 25° C. to 150° C.) at a total pressure of one atmosphere.

The initiator used in the polymerization can be suitably selected from known or commonly used polymerization initiators in accordance with the type of the polymerization method. For instance, an azo-based polymerization initiator can be preferably used. Examples of an azo-based polymerization initiator include 2,2′-azobisisobutyronitrile, 2,2′-azobis(2-methylpropionamidine) disulfate salt, 2,2′-azobis(2-amidinopropane) dihydrochloride, 2,2′-azobis[2-(5-methyl-2-imidazolin-2-yl)propane]dihydrochloride, 2,2′-azobis(N,N′-dimethylene isobutylamidine), 2,2′-azobis[N-(2-carboxyethyl)-2-methylpropionamidine]hydrate, 2,2′-azobis(4-methoxy-2,4-dimethylvaleronitrile), 2,2′-azobis(2,4-dimethylvaleronitrile), 2,2′-azobis(2-methylbutyronitrile), 1,1′-azobis(cyclohexane-1-carbonitrile), 2,2′-azobis(2,4,4-trimethylpentane), dimethyl-2,2′-azobis(2-methylpropionate), and so on.

Other examples of a polymerization initiator include persulfates such as potassium persulfate salts, ammonium persulfate, etc.; peroxide-based initiators such as benzoyl peroxide, t-butyl hydroperoxide, di-t-butyl peroxide, t-butyl peroxybenzoate, dicumyl peroxide, 1,1-bis(t-butylperoxy)-3,3,5-trimethylcyclohexane, 1,1-bis(t-butylperoxy)cyclododecane, hydrogen peroxide, etc.; substituted-ethane-based initiators such as phenyl-substituted ethane, etc.; aromatic carbonyl compounds; and so on. Yet other examples of a polymerization initiator include redox-based initiators by combination of a peroxide and a reducing agent. Examples of such a redox-based initiator include combination of a peroxide and ascorbic acid (combination of hydrogen peroxide water and ascorbic acid, etc.), combination of a peroxide and a iron(II) salt (combination of hydrogen peroxide water and a iron(II) salt, etc.), combination of a persulfate salt and sodium hydrogen sulfite, and the like.

These polymerization initiators can be used as a single kind alone or in combination of two or more kinds. The polymerization initiator can be used in a usual amount, which can be selected, for instance, from a range of about 0.005 to 1 part by mass (typically 0.01 to 1 part by mass) relative to 100 parts by mass of all monomer components.

According to such solution polymerization, can be obtained a polymerization reaction mixture in an embodiment where an acrylic polymer is dissolved in an organic solvent. As the acrylic polymer in the art disclosed herein, the polymerization reaction mixture or the reaction mixture after suitable work-up procedures can be preferably used. In typical, a post-work-up acrylic-polymer-containing solution adjusted to a suitable viscosity (concentration) is used. Alternatively, an acrylic polymer can be synthesized by a different polymerization method (e.g., emulsion polymerization, photopolymerization, bulk polymerization, etc.) other than the solution polymerization method, and a solution prepared by dissolving the resulting polymer in an organic solvent may be used.

In the art disclosed herein, when the weight average molecular weight (Mw) of the acrylic polymer is too small, the cohesive strength of the PSA may turn out insufficient, whereby it is likely to leave adhesive residue on the adherend surface, or the curved surface adhesion may tend to decrease. On the other hand, when the Mw is too large, the adhesive strength against an adherend may tend to decrease. In order to achieve high levels of adhesive properties and removability in a balance, preferable is an acrylic polymer having a Mw in a range of 10×10⁴ or larger, but 500×10⁴ or smaller. According to an acrylic polymer having a Mw of 20×10⁴ or larger, but 400×10⁴ or smaller (e.g., 30×10⁴ or larger, but 300×10⁴ or smaller), even better results may be produced. Mw herein refers to a value based on standard polystyrene determined by GPC (gel permeation chromatography).

The PSA composition in the art disclosed herein may have a composition containing a tackifier resin. As the tackifier resin, can be used various tackifier resins such as rosin-based, terpene-based, hydrocarbon-based, epoxy-based, polyamide-based, elastomer-based, phenol-based, ketone-based tackifier resins and the like, although not particularly limited to these. These tackifier resins can be used as a single kind alone, or in combination of two or more kinds.

Examples of a rosin-based tackifier resin include unmodified rosins (raw rosins) such as gum rosin, wood rosin, tall-oil rosin, etc.; modified rosins from the modification of these raw rosins by hydrogenation, disproportionation, polymerization, and so on (hydrogenated rosins, disproportionated rosins, polymerized rosins, other chemically modified rosins, and the like); other various rosin derivatives; and the like. Examples of the rosin derivatives include rosin esters such as unmodified rosins esterified with alcohols (i.e., esterification products of unmodified rosins), modified rosins (hydrogenated rosins, disproportionated rosins, polymerized rosins and the like) esterified with alcohols (i.e., esterification products of modified rosins), and the like; unsaturated fatty acid-modified rosins such as unmodified rosins and modified rosins (hydrogenated rosin, disproportionated rosin, polymerized rosin and the like) modified with unsaturated fatty acids; unsaturated fatty acid-modified rosin esters such as rosin esters modified with unsaturated fatty acids; rosin alcohols from the reductive treatment of a carboxyl group in unmodified rosins, modified rosins (hydrogenated rosins, disproportionated rosins, polymerized rosins, etc.), unsaturated fatty acid-modified rosins or unsaturated fatty acid-modified rosin esters; metal salts of rosins such as unmodified rosins, modified rosins, various rosin derivatives, etc., (in particular, of rosin esters); rosin phenol resins obtainable from the addition of phenol to rosins (unmodified rosin, modified rosin, various rosin derivatives, etc.) by heat polymerization in the presence of an acid catalyst; and so on.

Examples of a terpene-based tackifier resins include terpene-based resins such as α-pinene polymers, β-pinene polymers, dipentene polymers, etc.; modified terpene-based resins from the modification (e.g., phenol modification, aromatic group modification, hydrogenation, hydrocarbon modification, and so on) of these terpene-based resins; and so on. Examples of the modified terpene-based resins include terpene-phenol-based resins, styrene-modified terpene-based resins, aromatic-group-modified terpene-based resins, hydrogenated terpene-based resins, and the like.

Examples of a hydrocarbon-based tackifier resin include various hydrocarbon-based resins such as aliphatic hydrocarbon resins, aromatic hydrocarbon resins, alicyclic hydrocarbon resins, aliphatic-aromatic petroleum resins (styrene-olefin-based copolymers, etc.), aliphatic-alicyclic petroleum resins, hydrogenated hydrocarbon resins, coumarone-based resins, coumarone-indene-based resins, and the like. Examples of an aliphatic hydrocarbon resins include polymers of one, two or more kinds of aliphatic hydrocarbons selected from olefins and dienes having about 4 to 5 carbon atoms, and the like. Examples of the olefin include 1-butene, isobutylene, 1-pentene, and the like. Examples of the diene include butadiene, 1,3-pentadiene, isoprene, and the like. Examples of an aromatic hydrocarbon resin include polymers of vinyl-group-containing aromatic hydrocarbons having 8 to 10 carbon atoms (styrene, vinyl toluene, α-methyl styrene, indene, methyl indene, etc.), and the like. Examples of a alicyclic hydrocarbon resins include products of polymerization of cyclic dimers of so-called “C4 petroleum fractions” and “C5 petroleum fractions”; polymers of cyclic diene compounds (cyclopentadiene, dicyclopentadiene, ethylidene norbornene, dipentene, etc.) or hydrogenation products of these polymers; alicyclic hydrocarbon-based resins obtainable by hydrogenation of aromatic rings in aromatic hydrocarbon resins or aliphatic-aromatic petroleum resins; and the like.

In the art disclosed herein, can be preferably used a tackifier resin having a softening point (softening temperature) of about 80° C. or above (preferably about 100° C. or above). According to such a tackifier resin, can be obtained a PSA sheet of higher performance (e.g., stronger adhesion). The upper limit of the softening point of the tackifier is not particularly limited. For instance, it can be about 200° C. or below (typically about 180° C. or below). The softening point of a tackifier resin as referred to herein is defined as a value measured in accordance with the softening point test method (ring and ball method) specified in either JIS K 5902 or JIS K 2207.

The amount of tackifier resin to be used is not particularly limited, and can be selected in accordance with the target adhesive properties (adhesive strength, etc.). For example, based on the solids content, relative to 100 parts by mass of the acrylic polymer, a tackifier resin is preferably used in an amount of about 10 to 100 parts by mass (more preferably 15 to 80 parts by mass, or even more preferably 20 to 60 parts by mass).

In the PSA composition, a crosslinking agent may be used as necessary. The type of crosslinking agent is not particularly limited, and can be suitably selected for use from known or commonly used crosslinking agents (e.g., isocyanate-based crosslinking agents, epoxy-based crosslinking agents, oxazoline-based crosslinking agents, aziridine-based crosslinking agents, melamine-based crosslinking agents, peroxide-based crosslinking agents, urea-based crosslinking agents, metal-alkoxide-based crosslinking agents, metal-chelate-based crosslinking agents, metal-salt-based crosslinking agents, carbodiimide-based crosslinking agents, amine-based crosslinking agents, etc.). One kind of crosslinking agent can be used alone, or two or more kinds can be used in combination. The amount of crosslinking agent to be used is not particularly limited. For instance, relative to 100 parts by mass of the acrylic polymer, it can be selected from a range of about 10 parts by mass or less (e.g., about 0.005 to 10 parts by mass, preferably about 0.01 to 5 parts by mass).

The PSA composition may contain as necessary various additives generally used in the field of PSA compositions, such as a leveling agent, a crosslinking co-agent, a plasticizer, a softening agent, a filler, a colorant (pigment, dye, etc.), an anti-static agent, an anti-aging agent, a ultraviolet light absorber, an anti-oxidant, a photostabilizing agent, and so on. With respect to these various additives, those heretofore known can be used by typical methods, and since these do not specifically characterize the present invention, detailed descriptions are omitted.

As the method for obtaining a double-faced PSA sheet from such a PSA composition, can be applied various methods heretofore known. For example, can be employed a method where the PSA composition is directly applied to and allowed to dry or cure on each face of a non-woven fabric substrate to form PSA layers, and release liners are overlaid on these PSA layers, respectively; or a method where a pre-formed PSA layer on a release liner is adhered to each face of a non-woven fabric substrate thereby transferring the respective PSA layers on the non-woven fabric substrate (the release liners can be utilized as is for protection of the PSA layers); etc. Different methods may be employed between the first PSA layer and the second PSA layer.

As the release liner, can be suitably selected and used a release liner known or commonly used in the field of double-faced PSA sheets. For example, can be preferably used a release liner having a constitution where a release treatment has been given to a surface of the substrate. As the substrate (subject of a release treatment) constituting a release liner of this type, a suitable material can be selected for use from various resin films, kinds of paper, fabrics, rubber sheets, foam sheets, metal foil, composites of these (e.g., sheets having a layered structure such as paper laminated with an olefin resin on both faces), and the like. The release treatment can be performed using a known or commonly used release agent (e.g., a silicone-based, a fluorine-based, or a long chained alkyl-based release agent, etc.) by a typical method. Or, a poorly adhesive substrate made of an olefin-based resin (e.g., polyethylene, polypropylene, a ethylene-propylene copolymer, a polyethylene-polypropylene mixture), or a fluorine-based polymer (e.g., polytetrafluoroethylene, poly(vinylidene fluoride)), etc., can be used as the release liner without any release treatment given to the substrate surfaces. Alternatively, such a poorly adhesive substrate can be used after a release treatment is given.

The PSA composition can be applied using a known or commonly used coater such as gravure roll coater, reverse roll coater, kiss roll water, dip roll coater, bar coater, knife coater, spray coater, or the like. Although not particularly limited, the coating amount of each PSA composition can be so as to form a PSA layer having a thickness of, for instance, about 20 μm to 150 μm (thickness per face) after dried (i.e., based on the solids content). From the standpoint of making the double-faced PSA sheet lighter and/or thinner in a balance with high levels of adhesive properties, the thickness of the PSA layer per face is suitably about 40 μm to 100 μm, or preferably about 40 μm to 75 μm (more preferably 45 μm to 70 μm, e.g., 50 μm to 65 μm). From the standpoint of facilitating the crosslinking reaction or increasing the production efficiency, etc., the PSA composition is preferably dried with heating. In usual, a drying temperature of, for instance, about 40° C. to 120° C. can be preferably employed.

The double-faced PSA sheet disclosed herein has a mass per area of 150 g/m² or smaller, preferably 140 g/m² or smaller, or more preferably 135 g/m² or smaller (e.g., 130 g/m² or smaller). In addition, 85% by mass or more (preferably 87% by mass or more, e.g., 87 to 92% by mass) of the double-faced PSA sheet corresponds to the mass of the PSA layers. Because the double-faced PSA sheet has such a high PSA content (% by mass), despite of its lightweight, it exhibits good adhesive properties (e.g., high adhesive strength and good curved surface adhesion). Since the double-faced PSA sheet comprises a non-woven fabric substrate containing φ≧6 μm Manila hemp fibers at a proportion of 25% or more (preferably 30% or more, but typically 50% or less) by the number of threads, it can combine the good adhesive properties and good removability (recyclability) at a high level. In addition, since the double-faced PSA sheet is lightweight, even if some residue (which may have been resulted from inadequate peeling, or may have been forgotten to be removed, etc.) of the double-faced PSA sheet remains through a recycling process, quality loss in the recycled component can be suppressed.

The lower limit of the mass per area of the double-faced PSA sheet is not particularly limited, but it is usually suitable to be 80 g/m² or larger, and it is preferable to be 90 g/m² or larger (e.g., 100 g/m² or larger). Such a double-faced PSA sheet may exhibit even better adhesive properties (e.g., adhesive strength, especially adhesive strength against rough surfaces). The upper limit of the mass fraction of the PSA in this double-faced PSA sheet is not particularly limited, but it is usually suitable to be 97% by mass or smaller, and it is preferable to be 95% by mass or smaller (more preferable to be 92% by mass or smaller, e.g., 90% by mass or smaller). Such a double-faced PSA sheet may be of even better removability.

The mass fraction of PSA contained in the total mass of the double-faced PSA sheet can be determined, for instance, by the following method: a double-faced PSA sheet subjected to measurement is cut into a square of 10 cm by 10 cm, and its mass W_{T} is weighed; this test piece is immersed in a suitable organic solvent (e.g., ethyl acetate) for 24 hours, and then, the PSA swollen with the organic solvent is removed (scraped off) from the non-woven fabric substrate; after repeating this process three times, the non-woven fabric substrate is washed with the organic solvent, allowed to dry, and the mass W_{S} of the non-woven fabric substrate is weighed; by substituting these values for the next formula: (W_{T}−W_{S})/W_{T}; the mass fraction of PSA can be calculated.

The double-faced PSA sheet disclosed herein may have a thickness H of 250 μm or smaller (in FIG. 1 as an example for illustration, the thickness of the double-faced PSA sheet refers to the overall thickness including non-woven fabric substrate 10 and PSA layers 21 and 22 provided on the two faces thereof (the thickness across first adhesive face 21A and second adhesive face 22A), with the thickness of the double-faced PSA sheet as referred to herein not including the thickness of release liners). The double-faced PSA sheet according to a preferable embodiment has a thickness of 200 μm or smaller, or more preferably 150 μm or smaller (e.g., 130 μm or smaller). A double-faced PSA sheet having such a small thickness is preferable because it allows a joint using the double-faced PSA sheet to have a smaller thickness (in other words, it allows the distance between the components attached to each other via the double-faced PSA sheet to be smaller). The double-faced PSA sheet disclosed herein has a high PSA content (% by mass); and therefore, despite of its thin body, it can exhibit good adhesive properties (e.g., high adhesive strength and good curved surface adhesion).

The double-faced PSA sheet disclosed herein has a ratio (h/H) of the thickness h of the non-woven fabric substrate to the thickness H of the double-faced PSA sheet of preferably 50% or smaller, or more preferably 45% or smaller (e.g., 43% or smaller). In a double-faced PSA sheet that satisfies such a thickness ratio (h/H), even if it is in an embodiment having a lighter weight or a thinner body, as shown in FIG. 1, surfaces 10A and 10B of non-woven fabric substrate 10 can be covered respectively with PSA layers 21 and 22 (more specifically, their upper portions 212 and 222) each having a suitable thickness. Thus, can be obtained double-faced PSA sheet 1 exhibiting even better adhesive properties (adhesive strength, curved surface adhesion, etc.). From the standpoint of combining adhesive properties and removability at a higher level, the thickness ratio (h/H) is suitably 25% or larger, or preferably 30% or larger (e.g., 35% or larger).

In the example shown in FIG. 1, the thickness of each of the portions of PSA layers 21 and 22 covering surfaces 10A and 10B of non-woven fabric substrate 10 (in other words, the thickness of each of upper portions 212 and 222 of PSA layers 21 and 22; hereinafter, this may be referred to as “substrate-covering thickness”) is preferably 25 μm or larger, or more preferably 30 μm or larger. Double-faced PSA sheet 1 having such a constitution may exhibit even better adhesive properties. From the standpoint of making a lighter (preferably, even thinner) double-faced PSA sheet, the thickness (substrate-covering thickness) of each of the portions of PSA layers 21 and 22 covering surfaces 10A and 10B of non-woven fabric substrate 10 is suitably 45 μm or smaller, and it is usually preferable to be 40 μm or smaller.

With respect to the double-faced PSA sheet disclosed herein, the tensile strength measured by the method described in the worked examples shown later may be 10.0 N/10 mm or greater either in the machine direction (MD tensile strength T_{MD}) or in the transverse direction (TD tensile strength, T_{TD}). A preferable double-faced PSA sheet has T_{MD} and T_{TD} of each 13.0 N/10 mm or greater, or more preferably 13.5 N/10 mm or greater, or even more preferably 14.0 N/10 mm or greater. A double-faced PSA sheet exhibiting such tensile strength values may be of even better removability (especially, less susceptible to tearing during its removal). Although the upper limit of the tensile strength T_{MD} or T_{TD} is not particularly limited, in view of the costs or the ease of reducing the weight, usually, a double-faced PSA sheet with at least one of T_{MD} and T_{TD} being 20.0 N/10 mm or smaller is advantageous.

It is preferable that the double-faced PSA sheet has a ratio of tensile strength T_{TD} to T_{MD} (TD to MD ratio (T_{TD}/T_{MD})) not substantially larger or smaller than 1. For instance, can be preferably used a double-faced PSA sheet having a T_{TD}/T_{MD} in a range of 0.8 to 1.2 (typically 0.8 to 1.1, e.g., 0.9 to 1.1). With a double-faced PSA sheet with such small direction dependence of tensile strength, when peeling it off from an adherend, the peeling direction is less likely to produce a difference in the removability. Therefore, good removability can be produced more stably, and inadequate peeling of the double-faced PSA sheet can be better prevented.

The art disclosed herein provides a double-faced PSA sheet exhibiting high adhesive properties against resin materials (adherends) such as acrylonitrile-butadiene-styrene copolymer resin (ABS), high impact polystyrene (HIPS), polymer alloy of polycarbonate and ABS (PCABS), and the like and also exhibiting good removability from these adherends.

The double-faced PSA sheet according to a preferable embodiment exhibits a 180° peel strength (measured by the method described in the worked examples shown later) of 12 N/20 mm or greater (more preferably 13 N/20 mm or greater, or even more preferably 14 N/20 mm or greater) against at least one kind of adherend among ABS, HIPS and PCABS. A particularly preferable double-faced PSA sheet has a 180° peel strength of 12 N/20 mm or greater (more preferably 13 N/20 mm or greater, or even more preferably 14 N/20 mm or greater) against two kinds (more preferably three kinds) of adherend among ABS, HIPS and PCABS. From the standpoint of the lightness and removability of the double-faced PSA sheet, a preferable double-faced PSA sheet usually has a 180° peel strength smaller than 20 N/20 mm (e.g., 19 N/20 mm or smaller) against at least one kind of adherend among ABS, HIPS and PCABS.

The double-faced PSA sheet according to another preferable embodiment exhibits a floating distance of 8 mm or smaller in a curved surface adhesion test (performed by the method described in the worked examples shown later) which employs at least one of ABS and HIPS as the adherend. The floating distance is preferably 5 mm or smaller, more preferably 3 mm or smaller, or even more preferably 1 mm or smaller, and it is particularly preferable to be smaller than 1 mm. An especially preferable double-faced PSA sheet exhibits curved surface adhesion that satisfies the floating distance described above against either of ABS and HIPS.

### EXAMPLES

Several worked examples relating to the present invention are described below, but the present invention is not intended to be limited to these examples. In the description below, “part(s)” and “%” are based on the mass unless otherwise specified.

### [Non-Woven Fabric Substrate]

In the following examples, double-faced PSA sheets were prepared using as the substrates the respective non-woven fabrics shown next:

S1: non-woven fabric constituted with 100% Manila hemp fibers (i.e., the constituent fibers consist of Manila hemp fibers) and containing φ≧6 μm fibers at a proportion of 31% by the number of threads.

S2: non-woven fabric constituted with 100% Manila hemp fibers and containing φ≧6 μm fibers at a proportion of 19% by the number of threads.

Table 1 shows the property data of non-woven fabrics S1 and S2. The grammages of the respective non-woven fabrics were measured based on JIS P 8124. The tensile strength, the tear strength, and the fiber diameter were measured respectively as described below.

### [Tensile Strength of Non-Woven Fabric]

Each non-woven fabric was cut into a 15 mm wide strip to prepare a test piece, with the machine direction (MD) of the non-woven fabric coinciding with the length direction. The test piece was set in a tensile tester (180 mm chuck interval), and based on JIS P 8113, at a tensile speed of 20 mm/min, was measured the tensile strength in the length direction (MD tensile strength), t_{MD} (kgf/15 mm; herein, 1 kgf equal to approximately 9.8 N). With respect to a test piece obtained by cutting the non-woven fabric into a 15 mm wide strip with the transverse direction (TD) thereof coinciding with the length direction, in the same manner, was measured the tensile strength in the transverse direction (TD tensile strength), t_{TD} (kgf/15 mm). In addition, from t_{TD}/t_{MD}, was calculated the TD to MD tensile strength ratio.

### [Tear Strength of Non-Woven Fabric]

Using an Elmendorf tester, in accordance with JIS P 8116, “Tear Strength Test Method for Paper and Paper Plate”, the tear strength of the respective non-woven fabrics were measured. More specifically, each non-woven fabric was cut to 63 mm width to prepare a test piece. At 23° C. and 65% RH, the test piece was set in an Elmendorf tearing tester (available from Tester Sangyo Co., Ltd.), and with a notch, were measured the tear strength in the machine (length) direction (MD) (MD tear strength) and the tear strength in the transverse direction (TD) (TD tear strength).

### [Fiber Diameter]

A 2 mm wide sample cut out from each non-woven fabric was fixed on a sample support, and a series of transmission images were scanned by a X-ray CT scanner. Scanning was performed for every 0.2° over a range of 0° to 180°. For every cross section image defined at a pixel size of 0.95 μm/pixel, cross sections of fibers appearing in the cross section image were computed, and based on the histogram of the computation results, the proportion (% by the number of threads) of fibers having an arbitrary fiber diameter relative to the entire distribution was computed. For the scanning, was used a micro CT available from Toyo Technica Inc., under model number “SKYSCAN 1172” at a tube voltage of 40 kV and a tube current of 250 μA.

Measurements and evaluations of the double-faced PSA sheets according to the respective examples were carried out as follows.

### [Mass Per Area]

The mass (total mass) per area of the double-faced PSA sheet according to each example was defined as a sum of the grammage of the non-woven fabric used as the substrate and the combined mass per unit area of the PSA layers provided on both faces (i.e., the mass of the release liners were not included). By dividing the combined mass of both PSA layers per area by the total mass, the mass fraction of the PSA layers was calculated.

### [Adhesive Strength]

The release liner covering one adhesive face of each double-faced PSA sheet was peeled off, and a 25 μm thick polyethylene terephthalate (PET) film was adhered to the exposed adhesive face for backing. This backed PSA sheet was cut into a size of 20 mm wide by 100 mm long to prepare a test piece (with the length direction of the test piece coinciding with the MD of the non-woven fabric substrate). The release liner covering the other adhesive face of the test piece was peeled off, and the test piece was pressure-bonded to the surface of an adherend by moving a 2 kg roller back and forth once. After this was left at 23° C. for 30 minutes, based on JIS Z 0237, using a tensile tester, the 180° peel strength (N/20 mm-width) was measured at a tensile speed of 300 mm/min in a measurement environment at 23° C. and 50% RH.

With respect to four kinds of adherend, namely, a stainless steel (SUS) plate, an ABS plate (available from Shin-Kobe Electric Machinery Co., Ltd.), a HIPS plate (available from Nippon Testpanel Co., Ltd.), and a PCABS plate, the adhesive strength was measured according to the procedures described above.

### [Curved Surface Adhesion]

Each double-faced PSA sheet was cut into a size of 20 mm wide by 180 mm long, the release liner covering one adhesive face was peeled off, and an aluminum piece (0.4 mm thick) cut into the same size was adhered to the exposed adhesive face for backing to prepare a test piece. The test piece was oriented so that the length direction thereof coincided with the MD of the non-woven fabric substrate. From the other adhesive face of the test piece, the release liner was peeled off, and the test piece was pressure-bonded using a laminating machine to a 200 mm long rectangular plate of an adherend, so that one end of the length direction of the test piece was placed to meet one end of the length direction of the adherend. The adherend along with the test piece was left in an environment at 23° C. and 50% RH for one day, and it was set in a jig of 190 mm wide (gap width) to form an arc with the aluminum-piece-side assuming the outer circumference of the arc (i.e., with the surface of the adherend having the test piece adhered on assuming the convex surface), and the resultant was stored at 70° C. for 72 hours. Following this, was observed whether or not the other end of the length direction of the test piece (i.e., the end of the test piece not reaching an end of the length direction of the adherend) floated off the surface of the adherend (ABS plate). When any floating was observed, the floating distance was measured. The measurement was performed using three test pieces (i.e., n=3) for each, and their mean value was calculated. With respect to two kinds of adherend, namely, ABS plate (available from Shin-Kobe Electric Machinery Co., Ltd.) and HIPS plate (available from Nippon Testpanel Co., Ltd.), the curved surface adhesion was evaluated according to the procedures described above.

### [Tensile Strength of PSA Sheet]

A double-faced PSA sheet according to each example was cut into a 10 mm wide strip to prepare a test piece, with the machine direction (MD) of its non-woven fabric substrate coinciding with the length direction of the test piece. The test piece was set in a tensile tester (50 mm chuck interval), and based on JIS P 8113, at a tensile speed of 100 mm/min, was measured the tensile strength in the length direction (MD tensile strength), T_{MD} (N/10 mm). Also, a double-faced PSA sheet according to each example was cut into a 10 mm wide strip to prepare a test piece, with the transverse direction (TD) of its non-woven fabric substrate coinciding with the length direction of the test piece, and in the same manner, was measured the tensile strength in the transverse direction (TD tensile strength), T_{TD} (N/10 mm). In addition, from T_{TD}/T_{MD}, was calculated the TD to MD tensile strength ratio.

### [Recyclability]

The release liner covering one adhesive face of each double-faced PSA sheet was peeled off, and a 25 μm thick PET film was adhered to the exposed adhesive face for backing. The backed PSA sheet was cut into a size of 20 mm wide by 100 mm long to prepare a test piece (with the length direction of the test piece coinciding with the MD of the non-woven fabric substrate). The release liner covering the other adhesive face of the test piece was peeled off, and the test piece was pressure-bonded to the surface of an adherend by moving a 2 kg roller back and forth once. After this was left in an environment at 60° C. and 90% RH for 30 days and subsequently stored in an environment at 23° C. and 50% RH for one day, the test piece was peeled off from the adherend under the same conditions as the 180° peel strength measurement (i.e., at a tensile speed of 300 mm/min, 180° peel). The post-peel surface of the adherend was visually observed, and the recyclability (removability) was graded to the following four levels.

E: no residue of the PSA sheet was observed (excellent removability).

G: a minute amount of PSA reside was remaining, but not to an extent to raise practical issue (good removability).

P: PSA sheet remained partially on the adhesion area (poor removability).

N: PSA sheet remained almost entirely on the adhesion area (not removable).

With respect to three kinds of adherend, namely, a ABS plate (available from Shin-Kobe Electric Machinery Co., Ltd.), a HIPS plate (available from Nippon Testpanel Co., Ltd.) and a PCABS plate, the recyclability (removability) was evaluated according to the procedures described above.

### [Visual Quality]

The release liner covering one adhesive face of each double-faced PSA sheet was peeled off, and a 50 μm thick PET film was adhered to the exposed adhesive face for backing. The backed PSA sheet was cut into a square of 100 mm by 100 mm to prepare a test piece. The release liner covering the other adhesive face of the test piece was peeled off, and the test piece was pressure-bonded to the surface of a black-colored plastic plate by moving a 2 kg roller back and forth once. By visually observing the test piece at a 45° angle relative to the plastic plate surface, the proportion of the visible texture of non-woven fabric appearing as white circles of 2 mm diameter or larger was evaluated. Based on the results, when the proportion of the visible texture was equal to or smaller than that of Example 2, it was graded to “G” (good transparency), and when the proportion of the visible texture was evidently larger than that of Example 2, it was graded to “P” (poor transparency).

The PSA composition used in the preparation of the double-faced PSA sheets according to the respective examples were prepared as follows.

### [Preparation of PSA Composition]

To a three-necked flask, were placed 3 parts of acrylic acid, 4 parts of vinyl acetate, 93 parts of n-butyl acrylate, 0.1 part of 2-hydroxyethyl acrylate, and 200 parts of toluene as a polymerization solvent. Under a nitrogen gas flow, the reaction mixture was stirred for two hours to eliminate oxygen gas from the polymerization system. After this, was added 0.15 part of 2,2′-azobisisobutylonitrile (AIBN). The reaction mixture was heated to 70° C., and the polymerization reaction was carried out for six hours. A polymer solution (a toluene solution of an acrylic polymer) was thus obtained. The resulting polymer had a weight average molecular weight of 70×10⁴.

To the polymer solution, relative to 100 parts of its solids content, were added 40 parts of a tackifier (a polymerized rosin, trade name “PENSEL D125” available from Arakawa Chemical Industries, Ltd.) and 1.4 part of an isocyanate-based crosslinking agent (trade name “CORONATE L” available from Nippon Polyurethane Kogyo Co., Ltd.) and toluene in an amount enough to obtain 35% final solids content. The resultant was sufficiently stirred to prepare acrylic PSA composition A1. This acrylic PSA composition had a viscosity of 10 Pa·s at 23° C. With respect to the PSA obtained from this composition, the temperature at the maximum of the shear loss modulus G″ was −25° C.

The temperature at the maximum of the shear loss modulus G″ of PSA was determined using a rheometer (trade name “ARES” available from Rheometrics Scientific, Inc.) by the following method.

In particular, PSA composition A1 was applied on top of the release liner and allowed to dry at 100° C. for two minutes to form a PSA layer of 100 μm thickness. Several layers of this PSA were overlaid to form a 1 mm thick PSA film (test sample). A disc of 7.9 mm diameter was cut out of this PSA film and placed between parallel plates. Using the rheometer, the temperature dependence of the loss modulus G″ was monitored, and the temperature corresponding to the maximum of G″ (temperature at which the G″ curve was maximal) was determined. The measurement conditions were as follows:

Measurement: shear mode

Temperature range: −70° C. to 150° C.

Heating rate: 5° C./min

Frequency: 1 Hz

### [Measurement of Weight Average Molecular Weight]

The weight average molecular weight (Mw) was measured with a GPC system available from Tosoh Corporation (HLC-8220GPC) and determined based on standard polystyrene. The measurement conditions were as follows:

Sample concentration: 0.2% by mass (tetrahydrofuran (THF) solution)

Injected amount of sample: 10 μL

Eluent: THF

How rate: 0.6 mL/min

Measurement temperature: 40° C.

Columns:

Sample column: TSK guard column SuperHZ-H (one piece)+TSK gel SuperHZM-H (2 pieces)

Reference column: TSKgel SuperH-RC (one piece)

Detector: differential refractometer (RI)

Using these non-woven fabrics and PSA composition, double-faced PSA sheets were prepared.

### Example 1

PSA composition A1 was applied to a release liner (trade name “75 EPS (M) Cream (Kai)” available from Oji Specialty Paper Co., Ltd.) having a release layer treated with a silicone-based release agent and allowed to dry at 100° C. for two minutes to form a PSA layer of approximately 60 μm thickness. Two sheets of this PSA-applied release liner were prepared and adhered to the two faces of non-woven fabric S1 (substrate), respectively, to prepare a PSA sheet according to Example 1. The two adhesive faces of this PSA sheet are protected as is with the release liners used in the preparation of the PSA sheet.

### Example 2

PSA composition A1 was applied to a release liner identical to that used in Example 1, and allowed to dry at 100° C. for two minutes to form a PSA layer of approximately 80 μm thickness. Two sheets of this PSA-applied release liner were prepared and adhered to the two faces of non-woven fabric S2 (substrate), respectively, to prepare a PSA sheet according to Example 2. The two adhesive faces of this PSA sheet are protected as is with the release liners used in the preparation of the PSA sheet.

### Example 3

Except that the thickness of each PSA layer formed on the release liner was made to be approximately 60 μm, in the same manner as Example 2, was prepared a double-faced PSA sheet according to Example 3.

### Example 4

Except that the thickness of each PSA layer formed on the release liner was made to be approximately 43 μm, in the same manner as Example 2, was prepared a double-faced PSA sheet according to Example 4.

The double-faced PSA sheets according to the respective examples were stored in an environment at 50° C. for three days, and the resulting evaluation samples were subjected to the evaluation tests described above. The results are shown in Table 2. Herein, the “lightness” under the overall evaluations in the table was graded to E (excellent) when the mass per area of the double-faced PSA sheet was 130 g/m² or smaller; M (medium) when larger than 130 g/m², but 150 g/m² or smaller; P (poor) when larger than 150 g/m².

It is noted that when double-faced PSA sheets having the constitutions according to Examples 1 to 4 were continuously fabricated by a coater, it was found out that the double-faced PSA sheet using non-woven fabric S1 were able to be fabricated as fast as the double-faced PSA sheet according to Example 2 using non-woven fabric S2, proving that the productivity was excellent (excellent productivity, indicated as “E” in the table).

TABLE 1

| | | Non-woven fabric | |
|---|---|---|---|
| | | S1 | S2 |
| Grammage | (g/m²) | 14 | 23 |
| Thickness | (μm) | 50 | 75 |
| Bulk density | (g/cm³) | 0.27 | 0.31 |
| MD tensile strength t_{MD} | (kgf/15 mm) | 0.55 | 0.98 |
| TD tensile strength t_{TD} | (kgf/15 mm) | 0.51 | 0.96 |
| TD to MD ratio | (t_{TD}/t_{MD}) | 0.927 | 0.980 |
| MD tear strength s_{mD} | (mN) | 400 | 750 |
| TD tear strength s_{TD} | (mN) | 440 | 760 |
| Fibers of φ ≧6 μm | (% by no. of threads) | 31 | 19 |

TABLE 2

| | | Example | | | |
|---|---|---|---|---|---|
| | | 1 | 2 | 3 | 4 |
| Total thickness of double-faced PSA sheet (μm) | | 120 | 160 | 120 | 85 |
| Non-woven fabric | | S1 | S2 | S2 | S2 |
| Mass per area (g/m²) | PSA | 111 | 155 | 111 | 67 |
| | Substrate | 14 | 23 | 23 | 23 |
| | Total | 125 | 178 | 134 | 90 |
| Mass fraction of PSA | | 89% | 87% | 83% | 74% |
| Substrate-covering thickness (μm) | | 35 | 43 | 25 | 5 |
| Adhesive strength (N/20 mm) | Adherend | | | | |
| | SUS | 16 | 16 | 15 | 7 |
| | ABS | 15 | 15 | 14 | 6 |
| | HIPS | 15 | 15 | 14 | 5 |
| | PCABS | 16 | 16 | 15 | 6 |
| Curved surface adhesion | Adherend | | | | |
| (mm) | ABS | <1 | <1 | <1 | 10 |
| | HIPS | <1 | <1 | <1 | 10 |
| MD tensile strength T_{MD} | (N/10 mm) | 15 | 20 | 20 | 20 |
| TD tensile strength T_{TD} | (N/10 mm) | 15 | 20 | 20 | 20 |
| TD to MD ratio | T_{TD}/T_{MD} | 1.00 | 1.00 | 1.00 | 1.00 |
| Recyclability | Adherend | | | | |
| | ABS | E | E | E | E |
| | HIPS | E | E | E | E |
| | PCABS | E | E | E | E |
| Overall evaluation | Lightness | E | P | M | E |
| | Adhesive properties | E | E | G | P |
| | Recyclability | E | E | E | E |
| | Visual quality | G | G | P | P |
| | Productivity | E | E | E | E |

As evident from Tables 1 and 2, the double-faced PSA sheet of Example 1 comprising non-woven fabric S1 as the substrate had a mass per area of 150 g/m² or smaller (more specifically, 130 g/m² or smaller), and despite of its weight being lighter by close to 30% relative to the double-faced PSA sheet of Example 2, it exhibited adhesive properties (adhesive strength and curved surface adhesion here) as good as those of Example 2. This indicates that by avoiding a significant reduction in the amount of PSA while making the grammage of the non-woven fabric lower, the double-faced PSA sheet was made lighter while achieving good adhesive properties. The mass fraction of PSA in the double-faced PSA sheet according to Example 1 was 85% by mass or larger (more specifically, 87 to 90% by mass), which was comparable or rather higher than the double-faced PSA sheet according to Example 2. This is considered as a factor that allowed the double-faced PSA sheet to maintain good adhesive properties while reducing the total thickness of the double-faced PSA sheet by 20% as compared to Example 2. In addition, non-woven fabric S1 contained as much as 25% or more (more specifically 30% or more) by the number of threads of Manila hemp fibers having a fabric diameter of 6 μm or larger, which was 1.2 fold of S2 or higher (more specifically 1.5 fold or higher). Such a characteristic of the non-woven fabric also contributed to the formation of a double-faced PSA sheet that was more resistant to tearing (that exhibited high adhesive strength as well as good removability from adherends) and was also lightweight.

On the contrary to this, among the double-faced PSA sheets using non-woven fabric substrate S2, which contained a smaller amount of Manila hemp fibers having a fiber diameter of 6 μm or larger, while Example 2 having a mass per area of about 180 g/m² exhibited good recyclability and good visual quality (transparency). As compared to Example 2, some loss in the visual quality was observed for Example 3 where the reduced weight was achieved by reducing the amount of PSA while using non-woven fabric S2. Moreover, in Example 4 where the amount of PSA was further reduced, in addition to some loss in the visual quality, significant weakening was observed in the adhesive strength and the curved surface adhesion.

To evaluate in more detail the effects that the fiber diameter of the non-woven fabric had on the properties of the double-faced PSA sheets, the data in relation to the configurations of non-woven fabrics S1 and S2, which were obtained in the fiber diameter measurement, are summarized in Table 3.

In addition, the air resistance R_{1/4} of non-woven fabrics S1 and S2 were measured by the following method: by overlaying four sheets of a non-woven fabric subjected to measurement, a sample of an approximately 50 mm by 50 mm square was obtained; this sample was set in a commercially available model B Gurley tester (645 mm² test area), and based on the Gurley tester method specified in BS P8117:1998, was measured the time required for 100 mL of air to permeate through the sample; and the measurement was performed with respect to five samples for each non-woven fabric, and the air resistance R_{1/4} (sec) of the non-woven fabric was determined as their mean value divided by 4.

TABLE 3

Non-woven
fabric

| | | S1 | S2 |
|---|---|---|---|
| Fibers of φ <5 μm | (% by no. of threads) | 43.4 | 54.9 |
| Fibers of φ ≧5 μm | (% by no. of threads) | 56.6 | 45.1 |
| Fibers of φ <6 μm | (% by no. of threads) | 69.39 | 80.57 |
| Fibers of φ ≧6 μm | (% by no. of threads) | 30.61 | 19.43 |
| Mean fiber diameter | (μm) | 5.45 | 4.81 |
| Air resistance R_{1/4} | (sec) | 0.05 | 0.10 |

As shown in Table 3, as compared to non-woven fabric S2, in non-woven fabric S1, the φ≧6 μm Manila hemp fiber content and the φ≧5 μm Manila hemp fiber content were both clearly higher, and the mean fiber diameter was also larger by at least 0.5 μm. As such, using constituent fibers of larger diameters is an attempt opposing the usual direction researched when producing a non-woven fabric having a lighter weight (having a smaller grammage). As a result, it is presumed that as compared to S2, S1 had more open space between non-woven fabric fibers (more interfiber open space within the non-woven fabric), and this gave rise to the significant decrease in the air resistance R_{1/4}. Moreover, it is considered that the interfiber space in the non-woven fabric was effectively filled with PSA, whereby the visual quality increased as compared to the configuration using the non-woven fabric having less interfiber space available for PSA to fill in, and a double-faced PSA sheet having higher peel strength was obtained as well.

Although specific embodiments of the present invention have been described in detail above, these are merely for illustrations and do not limit the scope of the claims. The art according to the claims includes various modifications and changes made to the specific embodiments illustrated above.

What is claimed is:

1. A double-faced pressure-sensitive adhesive sheet comprising:
a non-woven fabric substrate having a first face and a second face; and
a pressure-sensitive adhesive layer provided on each of the first face and the second face of the non-woven fabric substrate, wherein
the double-faced pressure-sensitive adhesive sheet has a mass per area of 150 g/m² or smaller,
85% of the mass of the double-faced pressure-sensitive adhesive sheet corresponds to the combined mass of the pressure-sensitive adhesive layers, and
the non-woven fabric substrate is constituted with fibers comprising Manila hemp fibers having a fiber diameter of 6 μm or larger at a proportion of 25% or more by the number of threads.

2. The double-faced pressure-sensitive adhesive sheet according to claim 1, wherein the double-faced pressure-sensitive adhesive sheet has a thickness of 200 μm or smaller.

3. The double-faced pressure-sensitive adhesive sheet according to claim 1, wherein when the double-faced pressure-sensitive adhesive has a tensile strength value, T_{MD}, in the machine direction thereof, and a tensile strength value, T_{TD}, in the transverse direction thereof, the double-faced pressure-sensitive adhesive sheet has a T_{TD}/T_{MD} value of 0.8 or larger, but 1.2 or smaller.

4. The double-faced pressure-sensitive adhesive sheet according to claim 1, wherein a primary component of each pressure-sensitive layer is an acrylic pressure-sensitive adhesive.

5. The double-faced pressure-sensitive adhesive sheet according to claim 1, wherein when the non-woven fabric substrate has a tensile strength value, t_{MD}, in the machine direction thereof, and a tensile strength value, t_{TD}, in the transverse direction thereof, the non-woven fabric substrate has a t_{TD}/t_{MD} value of 0.8 or larger, but 1.2 or smaller.

6. The double-faced pressure-sensitive adhesive sheet according to claim 1, wherein the non-woven fabric substrate is constituted with fibers comprising 95% by mass or more of Manila hemp fibers.

7. The double-faced pressure-sensitive adhesive sheet according to claim 2, wherein when the double-faced pressure-sensitive adhesive has a tensile strength value, T_{MD}, in the machine direction thereof, and a tensile strength value, T_{TD}, in the transverse direction thereof, the double-faced pressure-sensitive adhesive sheet has a T_{TD}/T_{MD} value of 0.8 or larger, but 1.2 or smaller.

8. The double-faced pressure-sensitive adhesive sheet according to claim 2, wherein a primary component of each pressure-sensitive layer is an acrylic pressure-sensitive adhesive.

9. The double-faced pressure-sensitive adhesive sheet according to claim 2, wherein when the non-woven fabric substrate has a tensile strength value, t_{MD}, in the machine direction thereof, and a tensile strength value, t_{TD}, in the transverse direction thereof, the non-woven fabric substrate has a t_{TD}/t_{MD} value of 0.8 or larger, but 1.2 or smaller.

10. The double-faced pressure-sensitive adhesive sheet according to claim 2, wherein the non-woven fabric substrate is constituted with fibers comprising 95% by mass or more of Manila hemp fibers.

11. The double-faced pressure-sensitive adhesive sheet according to claim 3, wherein a primary component of each pressure-sensitive layer is an acrylic pressure-sensitive adhesive.

12. The double-faced pressure-sensitive adhesive sheet according to claim 3, wherein when the non-woven fabric substrate has a tensile strength value, t_{MD}, in the machine direction thereof, and a tensile strength value, t_{TD}, in the transverse direction thereof, the non-woven fabric substrate has a t_{TD}/t_{MD} value of 0.8 or larger, but 1.2 or smaller.

13. The double-faced pressure-sensitive adhesive sheet according to claim 3, wherein the non-woven fabric substrate is constituted with fibers comprising 95% by mass or more of Manila hemp fibers.

14. The double-faced pressure-sensitive adhesive sheet according to claim 4, wherein when the non-woven fabric substrate has a tensile strength value, t_{MD}, in the machine direction thereof, and a tensile strength value, t_{TD}, in the transverse direction thereof, the non-woven fabric substrate has a t_{TD}/t_{MD} value of 0.8 or larger, but 1.2 or smaller.

15. The double-faced pressure-sensitive adhesive sheet according to claim 4, wherein the non-woven fabric substrate is constituted with fibers comprising 95% by mass or more of Manila hemp fibers.

16. The double-faced pressure-sensitive adhesive sheet according to claim 5, wherein the non-woven fabric substrate is constituted with fibers comprising 95% by mass or more of Manila hemp fibers.
